(19) United States
(12) Patent Application Publication
(10) Pub. No.: US 2014/0095302 A1
(43) Pub. Date: Apr. 3, 2014

(54) Enhanced Commercial Offer Presentation System

(71) Applicant: Dante Monteverde, Barrington Hills, IL (US)

(72) Inventor: Dante Monteverde, Barrington Hills, IL (US)

(21) Appl. No.: 14/100,169

(22) Filed: Dec. 9, 2013

Related U.S. Application Data
(63) Continuation-in-part of application No. 13/292,428, filed on Nov. 9, 2011.
Application No. 13/292,428 is a continuation-in-part of application No. 13/082,008, filed on Apr. 7, 2011, now abandoned.

(51) Int. Cl. G06Q 30/02

(52) U.S. Cl. CPC G06Q 30/0261; G06Q 30/0264; G06Q 30/0248
USPC 705/14.47; 705/14.58

(57) ABSTRACT

The present application discloses devices, methods and systems that target a user with commercial offers having geographic and/or time-based qualities. The invention can include an aggregation system that presents the user with a map showing aggregated data for a plurality of commercial offers within a predetermined geographic area. The commercial offers can be presented to users in a staggered time-based manner to negate or minimize overwhelming a vendor with a large but temporary increase in business due to a plurality of users utilizing commercial offers. The commercial offer can also diminish over time to better determine the ability of the commercial offer system to acquire repeat business for the vendor.

### CROSS REFERENCE TO RELATED APPLICATION

The present application is a continuation-in-part of U.S. patent application Ser. No. 13/292,428, filed Nov. 9, 2011, which is a continuation-in-part of U.S. patent application Ser. No. 13/082,008, filed Apr. 7, 2011, the contents of which are hereby incorporated by reference in their entirety.

### TECHNICAL FIELD OF THE INVENTION

The present invention relates generally to presenting commercial offers to a user, and more specifically, to presenting commercial offers to a user according to time-based or geography-based qualities.

### BACKGROUND OF THE INVENTION

Internet-based “deal of the day” coupon offerings have become popular in recent years. Discounts of this sort are typically sent in deal of the day coupons to members of a predetermined list. If a sufficient number of people agree to the group discount, the group discount becomes available to all members of the list. However, if a predetermined threshold of people do not agree to accept the group coupon, the deal will not become available to the members of the list. This business model has been successful because it allows a large group to receive discounted offers for products or services, while allowing businesses to require a predetermined number of users to accept the discount so that their product or service may be sold in bulk.

Commercial offers can be provided to a customer in the form of a daily email or an Internet link that the user can select. Users sometimes overlook emails containing commercial offers or such emails are automatically forwarded to a “spam” or “junk” folder and never seen by the user. Also, commercial offer emails and links rarely account for the geography of the vendor making the offer, much less display a map related to the vendor or other commercial offers available within a predetermined geography. A need exists for a commercial offer presentation system and method that aggregates such commercial offers and presents the offers to users in a manner that facilitates a purchase.

Current commercial offer presentation systems also simultaneously present a single commercial offer to all of the system's users rather than staggering the commercial offers over a period of time. Vendors can easily become overwhelmed by the temporary increase in business and struggle to appropriately staff or maintain inventory during increased business periods caused by customer use of the offers.

In addition, conventional commercial offer systems provide commercial offers with only a fixed discount that does not change over time. Users normally purchase the commercial offer and conduct repeat business with the vendor over time without any further discount. In this manner, the commercial offer system can be considered quite successful as a customer acquisition tool that results in repeat business for the vendor. However, such repeat business is conducted independent of the commercial offer system and with no way of linking the repeat business with the commercial offer system. As a result, the commercial offer system does not receive the appropriate credit for obtaining the customer to conduct the repeat business.

### BRIEF SUMMARY OF THE INVENTION

The present application discloses devices, methods and systems that target a user with commercial offers having geographic and/or time-based qualities. The present invention can include an aggregation system that presents the user with data showing the total amount of discounts for a predetermined geographic area, the total number of commercial offers in a geographic area, or other aggregated information that may facilitate user purchase and acceptance of a commercial offer. The present invention can also present commercial offers to users in a staggered time-based manner to negate or minimize overwhelming a vendor with a large, but typically temporary, increase in business due to a plurality of customers using commercial offers. In addition, the present invention can present a commercial offer to a user where the commercial offer diminishes over time. In this manner, the vendor can offer a larger initial discount to acquire customers, and subsequently decrease the amount of the discount to a sustainable level while still connecting the discount to the commercial offer system. Accordingly, the commercial offer system can be given credit by maintaining records of users who purchased the commercial offer at the larger initial discount and, even when the discount was subsequently reduced to smaller levels, such users returned to the vendor for repeat business.

For example, the present application discloses a method of providing commercial offers to a user including determining a target geographic area of the user; determining the commercial offers that are within the target area of the user; aggregating the commercial offers, with a server having a processor, to obtain aggregated commercial offer data; and causing the display of the aggregated commercial offer data on a user device.

The present application also discloses a method of presenting a commercial offer to a user including establishing a discount amount of the commercial offer; determining, by a server having a processor, a discount schedule wherein the discount amount of the commercial offer is changed over a period of time; and causing the commercial offer to be displayed on a user device.

Also disclosed is a method of presenting a commercial offer to a user including establishing a discount amount of the commercial offer; determining, by a server having a processor, a discount schedule wherein the discount amount of the commercial offer is changed over a period of time; and causing the commercial offer to be displayed on a user device.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages should be readily understood and appreciated.

FIG. 1 is a schematic diagram of a network incorporating an embodiment of the present invention;

FIG. 2 is a schematic diagram illustrating the hardware components of an embodiment of a user device of the present invention;

FIG. 3 is a flow chart of an embodiment of the present invention depicting a method for presenting relevant commercial offers to a user;

FIG. 4 is a flow chart of an embodiment of the present invention depicting a method for determining a geographic point of interest of the user;

FIG. 5 is a flow chart of an embodiment of the present invention depicting a method for determining a target area based on the established geographic points of interest of the user;

FIGS. 6(a)-(c) are illustrations of a display showing several exemplar geographic points of interest of the user in accordance with an embodiment of the present invention;

FIG. 7(a) is an exemplar illustration of a display showing a user-modified target area based on the geographic points of interest;

FIG. 7(b) is an exemplar illustration of a display showing a completed custom target area; and

FIG. 8 is a flow chart of a method of providing a commercial offer to a user.

### DETAILED DESCRIPTION OF PREFERRED EMBODIMENTS

While the present invention is susceptible of embodiments in many different forms, there is shown in the drawings and will herein be described a preferred embodiment of the invention with the understanding that the present disclosure is to be considered as an exemplification of the principles of the invention and is not intended to limit the broad aspect of the invention to embodiments illustrated.

The present application discloses a system and method that targets a user with a commercial offer having geographic and/or time-based qualities. The disclosed system can include an aggregation system that presents the user with a display showing aggregated commercial offer data for a plurality of commercial offers. Alternately, or in addition to the above, the commercial offer can be presented to a plurality of users in a staggered time-based manner to negate or minimize overwhelming a vendor with a large, but typically temporary, increase in business due to a plurality of customers using offers. The commercial offer can also diminish over time to better determine the ability of the commercial offer system to acquire repeat business for the vendor.

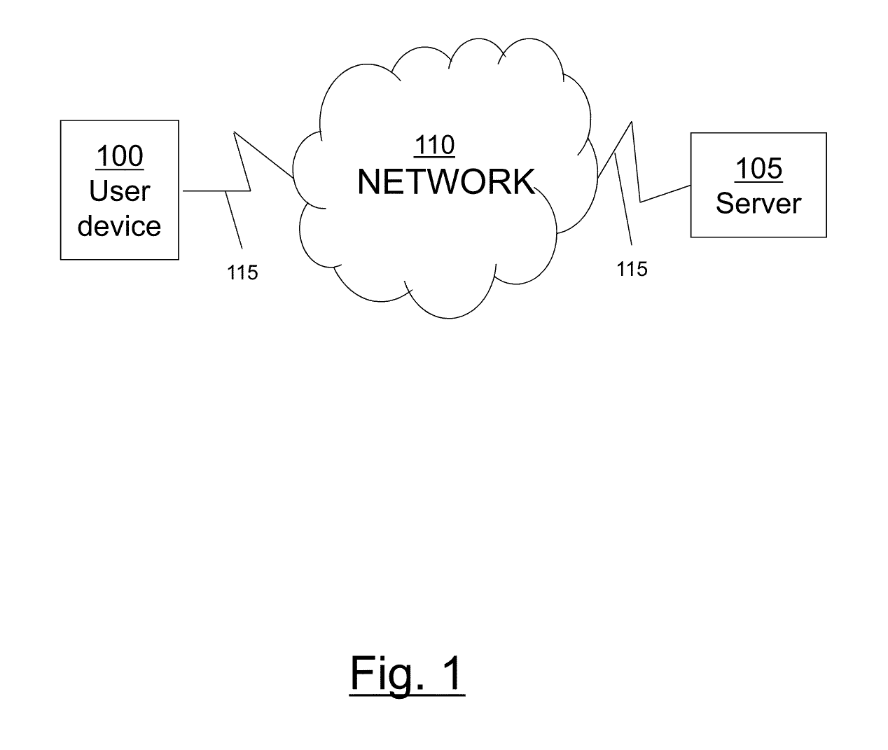

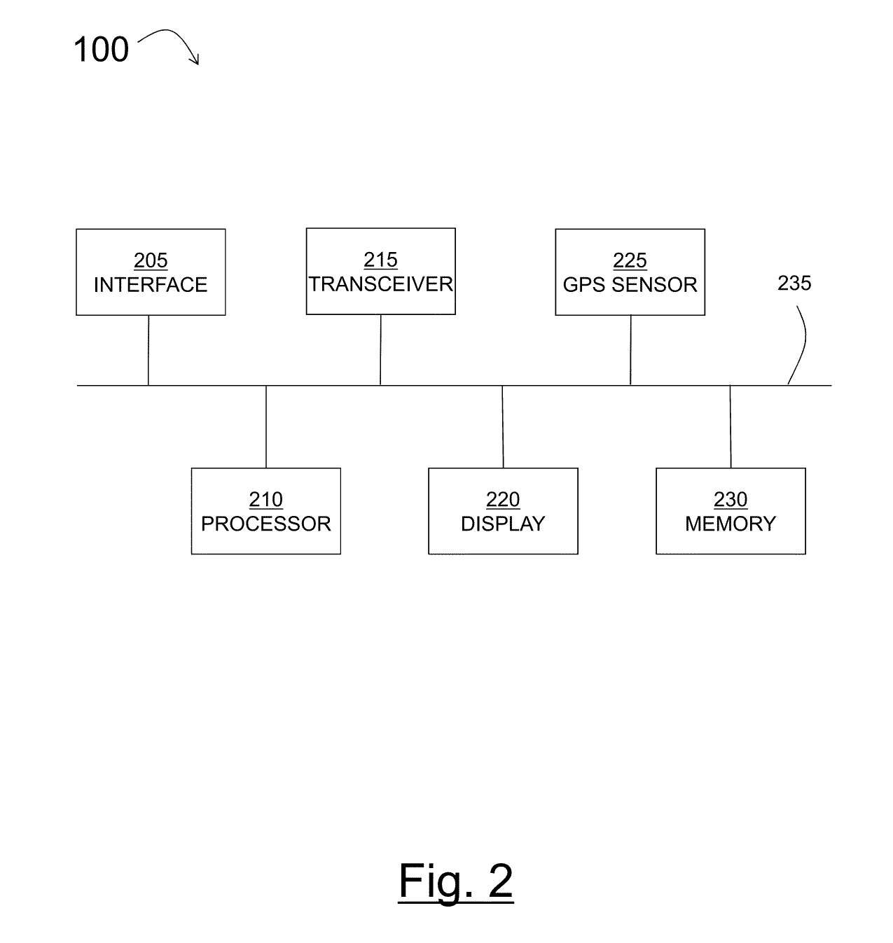

In an embodiment, and referring to FIG. 1, a user device 100 may be operably coupled to a server 105 via a network 110 by way of communication links 115, such as, for example, the Internet. The user device 100 communicates with the server 105 to transmit data to and receive data from server 105. Such data can include, for example, messages or requests to publish messages, travel announcements, search queries from the user, commercial offers received from the server 105 to the user device 100, and data that depicts geographic points of interest of the user or target geographic area of the user. Any other relevant data can be transmitted from the user device 100 to the server 105 without departing from the spirit and scope of the present application. As discussed below, based on geographic points of interest of the user, an embodiment of the present invention determines a geographic target area that more closely identifies a geographic area that the user is likely to frequent and conduct business. In an embodiment, the user can view aggregated commercial offer data for vendors within the target area, such as, for example, the amount of savings available within the target area, a total amount of savings that will expire within a predetermined time, the total number of commercial deals in the target area at any given time, or any of the above data types for a category of commercial offers. Any other form of data aggregation can also be performed and displayed to the user within the spirit and scope of the present invention.

As used herein, the term “geographic points of interest” can include any geographic point and can be determined either manually by user input or automatically if the user has not input any custom geographic points of interest. By way of example, common geographic points of interest may include the location of the user's home, the location of the user's work, the location of the user's children's school, the location of the user's church, synagogue, mosque, or other place of worship, restaurants, or other businesses or locations commonly frequented by the user, or any other location that may help define the routine of the user and/or the locations where the user is likely to do business.

It will be understood that the intent is that the preferred geographic points of interest are those points where the user typically travels to, from and/or within, although any points of interest can be included, such as, for example, a location where the user is going on a vacation. As discussed below, based on the geographic points of interest of the user, the embodiments of the present application determine a target area that more closely identifies a geographic area that the user is likely to frequent and subsequently conduct business with vendors. As used herein, the term “vendor” means anyone or entity that conducts business, for example, stores, merchants, and the like.

Commercial offers can include any offer from a vendor capable of being transmitted over the network 110, or any representation of the vendor's business. For example, a consumer offer can include a link to a website in a list of search results, a coupon offer emailed to the user or otherwise accessed by the user, a list of prices for relevant products or services, or any other means of communicating a potential commercial transaction. The commercial offers are typically provided from vendors located in the user's target area, but commercial offers from any vendor can be distributed to the user without departing from the spirit and scope of the present application.

The user device 100 can be a device of any type that allows the transmission and/or reception of data. By way of example, the user device 100 can include a smart phone (e.g. iPhone®), personal computer, voice and video telephone set, streaming audio and video media player, integrated intelligent digital television receiver, DVS receiver, work station, radio, personal digital assistant (PDA), mobile satellite receiver, GPS receiver, software system, or any combination of the above.

The server 105 can also be a device of any type that allows for the transmission and/or reception of data, and that is capable of storing information to be transmitted to the user device 100. For example, the server 105 can include any device listed above with respect to the user device 100, or can include a non-transitory computer-readable recording medium, such as a hard drive, DVD, CD, flash drive, volatile or non-volatile memory, RAM, or any other type of data storage.

The network 110 may be a single network or a plurality of networks of the same or different type. For example, the network 110 may include a local telephone network (such as a Bell Atlantic telephone number) in connection with a long distance network (such as an AT&T long distance telephone network). Further, the network 110 may be a data network, an Intranet, the Internet or a telecommunications network in connection with a data network. Any combination of telecommunications and data networks may be used without departing from the spirit and scope of the present application. For purposes of discussion, it will be assumed that the network 110 is the Internet.

FIG. 2 is a schematic diagram illustrating exemplar hardware components of a user device 100 using an embodiment of the present invention. As shown, the user device 100 can include an interface 205, processor 210, transceiver 215, display 220, GPS sensor 225 and a memory 230 connected via a bus 235.

The interface 205 allows the user to input information or commands into the user device 100 and to transmit the information or command to the server 105 via the network 110. By way of example, the interface can include a keyboard, mouse, touch screen, audio recorder, audio transmitter, member pad, voice-to-text or any other device that allows for the entry of information from a user.

In an embodiment, a GPS sensor 225 is provided and adapted to allow the user device 100 to determine GPS coordinates and thus determine the user's geographic orientation. The GPS coordinates of the user device 100 can be used to determine various geographic points of interest of the user without having to prompt the user to manually input such geographic points of interest.

Similar to the server 105 discussed above, the memory 230 can include any non-transitory computer-readable recording medium, such as a hard drive, DVD, CD, flash drive, volatile or non-volatile memory, RAM, or any other type of data storage.

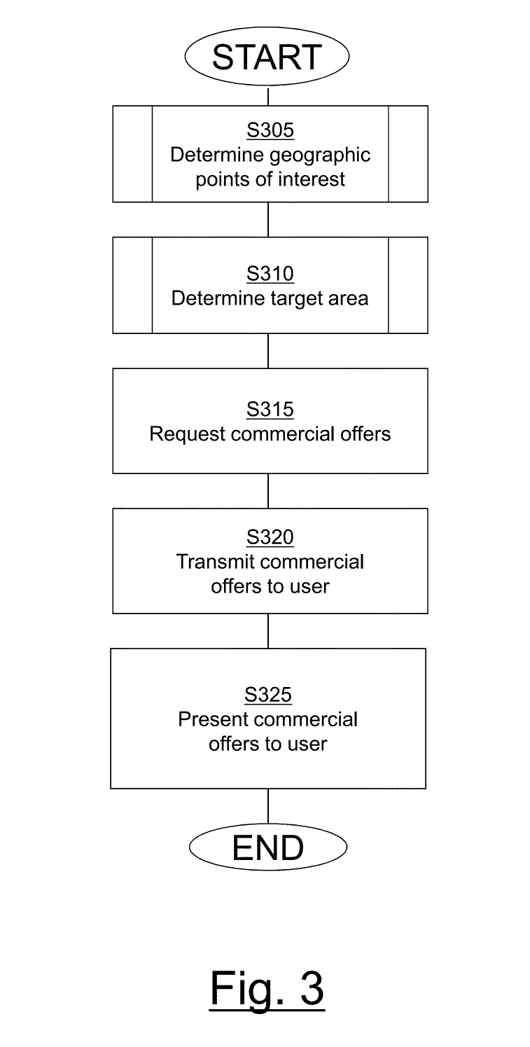

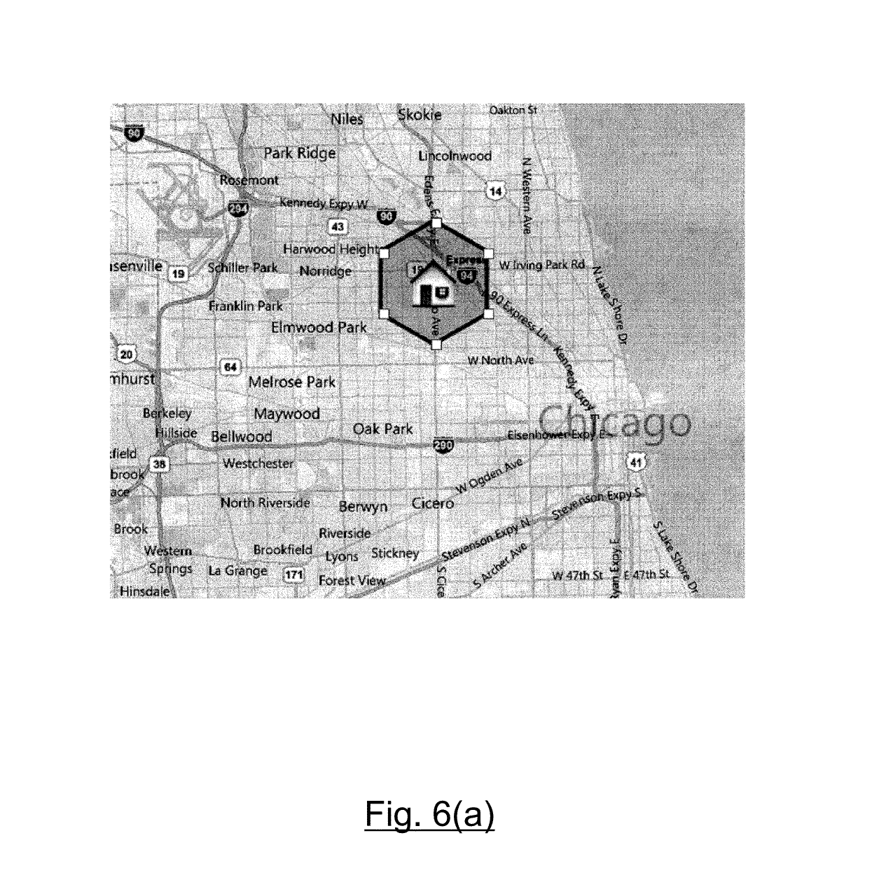

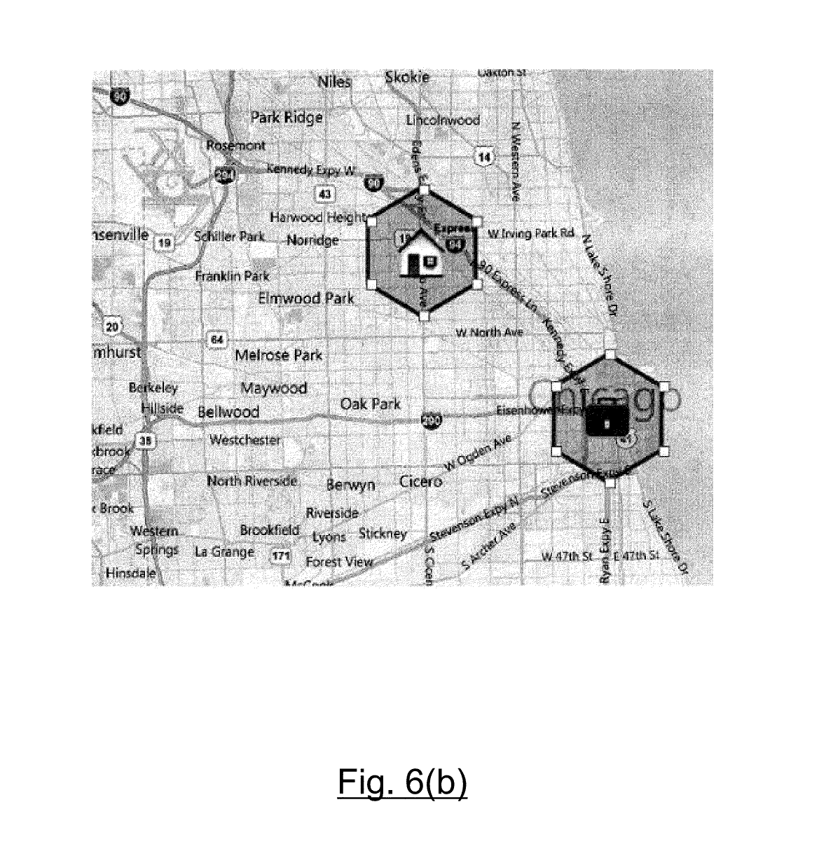

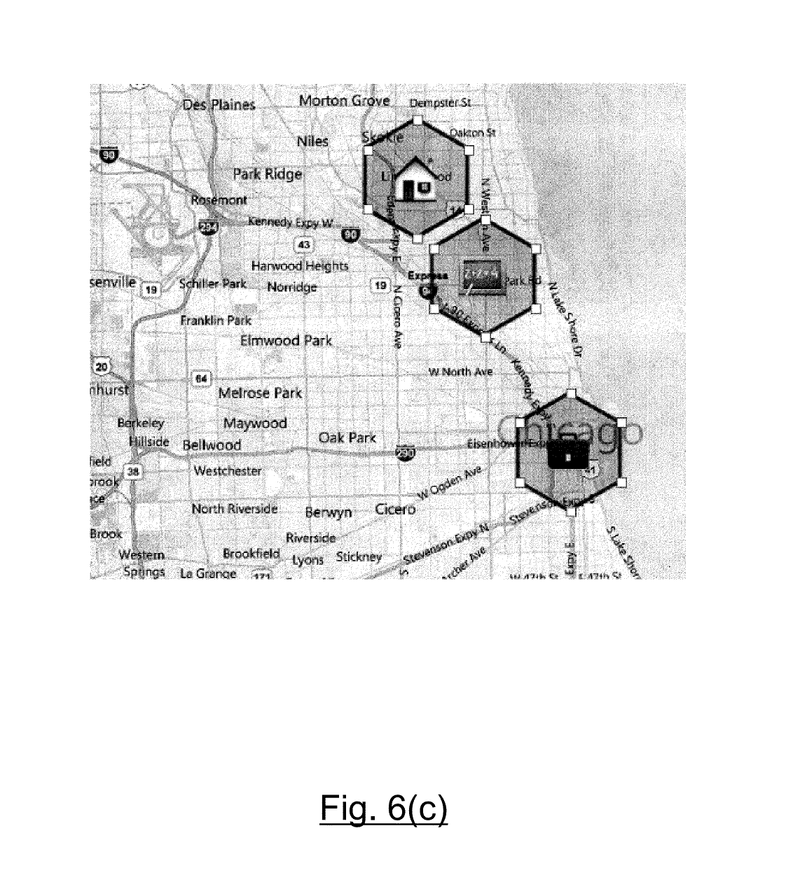

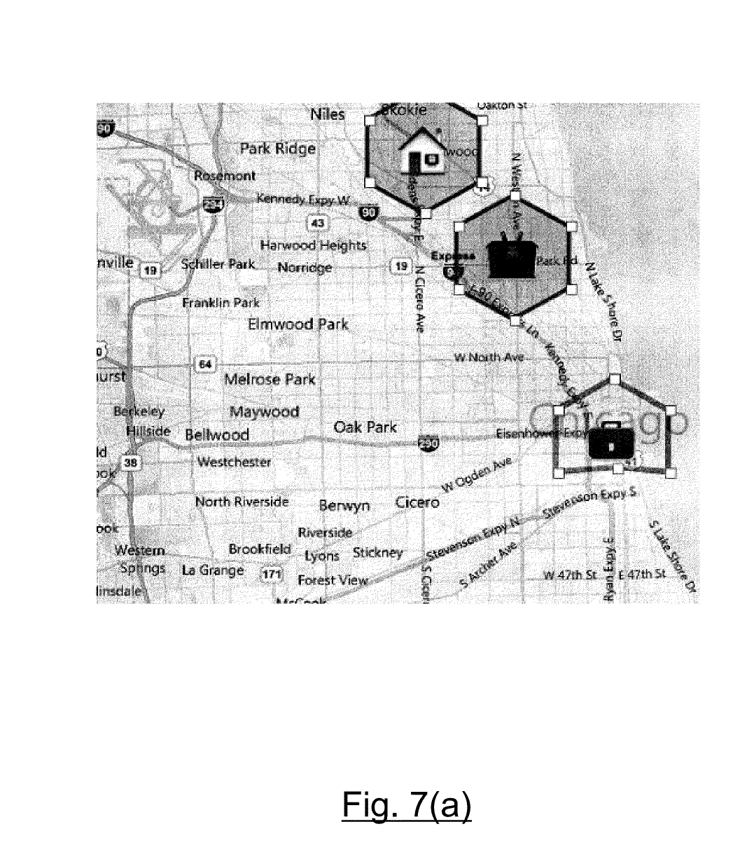

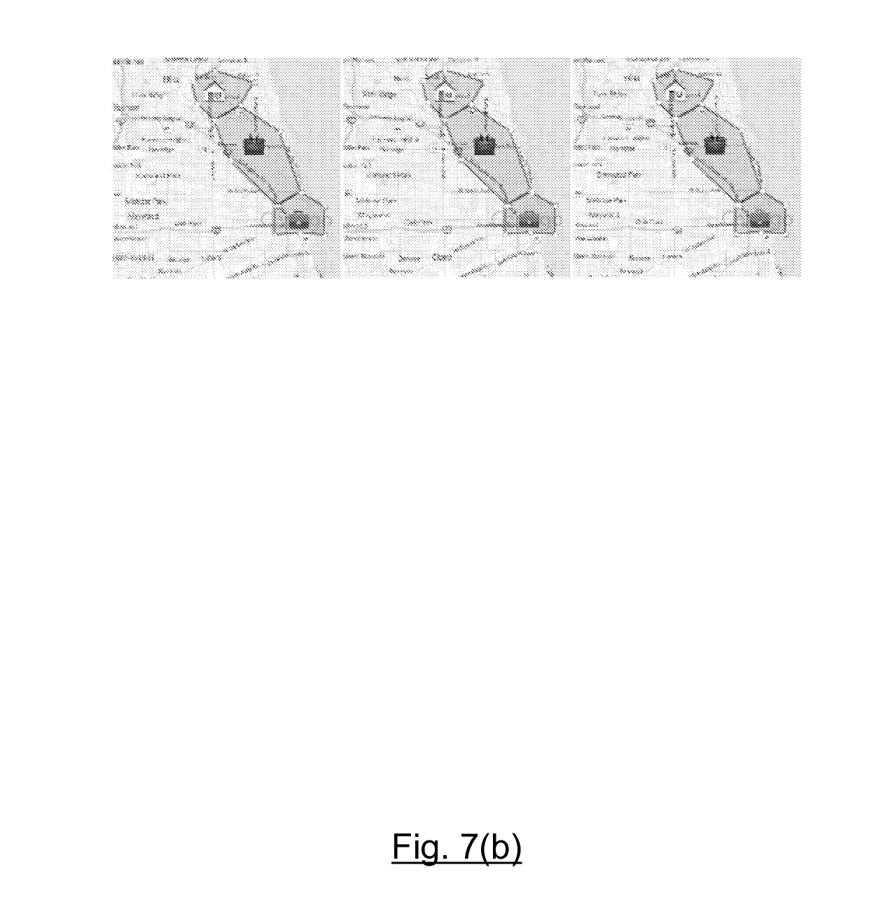

FIG. 3 illustrates a flow chart depicting an embodiment of the present invention in which commercial offers are transmitted and presented to relevant potential buyers based on their preferred, typical geographic points of travel. The process starts at S305, where geographic points of interest are determined by either manually asking the user to input geographic points of interest or by automatically determining the geographic points of interest based on various factors, such as, for example, GPS. As discussed above, the geographic points of interest represent specific locations in which the user is likely to travel based on his or her routine and/or based on areas that the user commonly frequents. Moreover, the geographic points of interest can be modified by typical click-and-drag capabilities and can be represented in any shape. Therefore, while the geographic points of interest are shown as hexagonal in FIGS. 6 and 7, it will be appreciated that other shapes can be used, such as, for example, circular, square, rectangular or polygonal. Moreover, the size of the shape can be modified in order to better represent the relevant geographic area of the user. For example, a circular shape could represent a 5-mile radius from a particular point of interest, wherein a vendor within the 5-mile radius would have their commercial offers provided to the user, and vendors outside of the 5-mile radius would not have their commercial offers displayed to the user since it is unlikely the user would conduct business with that vendor. Moreover, the points of interest can further be interconnected to designated preferred travel corridors when the user travels between the different points of interest. For example, the home point of interest can be interconnected with the work point of interest, wherein geographically relevant vendors along the designated travel route may have their commercial offers provided to the user.

Once the geographic points of interest are established in S305, the process proceeds to S310, where the target area can be determined based on established geographic points of interest. The target area can be an area that depicts where the user frequently is located or travels based on his or her routine in a broader sense than that depicted in S305 with respect to the geographic points of interest. As discussed below, the target area may be modified by the user or may be automatically modified by the user device 100 to provide a more narrowly tailored target area for the particular user.

Once the target area has been established in S310, commercial offers can be requested in S315 by the user device, or alternately, commercial offers can be provided to the user on a periodic basis without a user request for such a commercial offer S315. For example, the user device 100 can enter various search terms into a search engine to request commercial offers or business websites in the particular search engine. Alternately, the user device 100 can request commercial offers through an on-demand type methodology in which the user knows in advance the vendor from which he or she would like to request and obtain a commercial offer. In yet another embodiment, the server 105 can provide the user device 100 with commercial offers in “deal of the day” emails or text messages.

Although FIG. 3 illustrates the user entering various search terms in a search engine after a target area has been established, the order of this process can vary. For example, the user can enter search queries prior to establishing a target area, or the user can be sent commercial offers without any search being conducted. In accordance with a group coupon delivery model, the user could purchase the commercial offer and, if enough of the commercial offers are purchased from other users, the vendor will honor the commercial offer.

After the commercial offers have been requested in S315, the commercial offers for vendors located in the target area where the user is located or commonly travels can be transmitted to the user in S320. The transmitted commercial offers can originate either from the server 105 or anywhere else within the network 110, for example, on an external user device 100 within a peer-to-peer network.

Once the commercial offers are transmitted to the user in S320, the commercial offers can be presented to the user in S325. The manner in which the commercial offers are presented to the user is not limited, and can include displaying the commercial offers on the display 220 or emitting an audio signal communicating the commercial offers. Once the user receives and hears or views the commercial offer, the user can accept the offer by traveling to the location of the vendor within the target area or by electronically accepting the offer on the user device 100. The commercial offers can be for vendors located in an area that is at or near an area that the user commonly frequents at a predetermined time of day. For example, the commercial offer can be for discounted coffee based on the knowledge that the user is likely to be located near the vendor during the morning hours, such as, for example, on his or her way to work. The user can thus be more closely targeted based on the daily, weekly, or otherwise periodic routines that link the user to a particular area at a particular time and/or day.

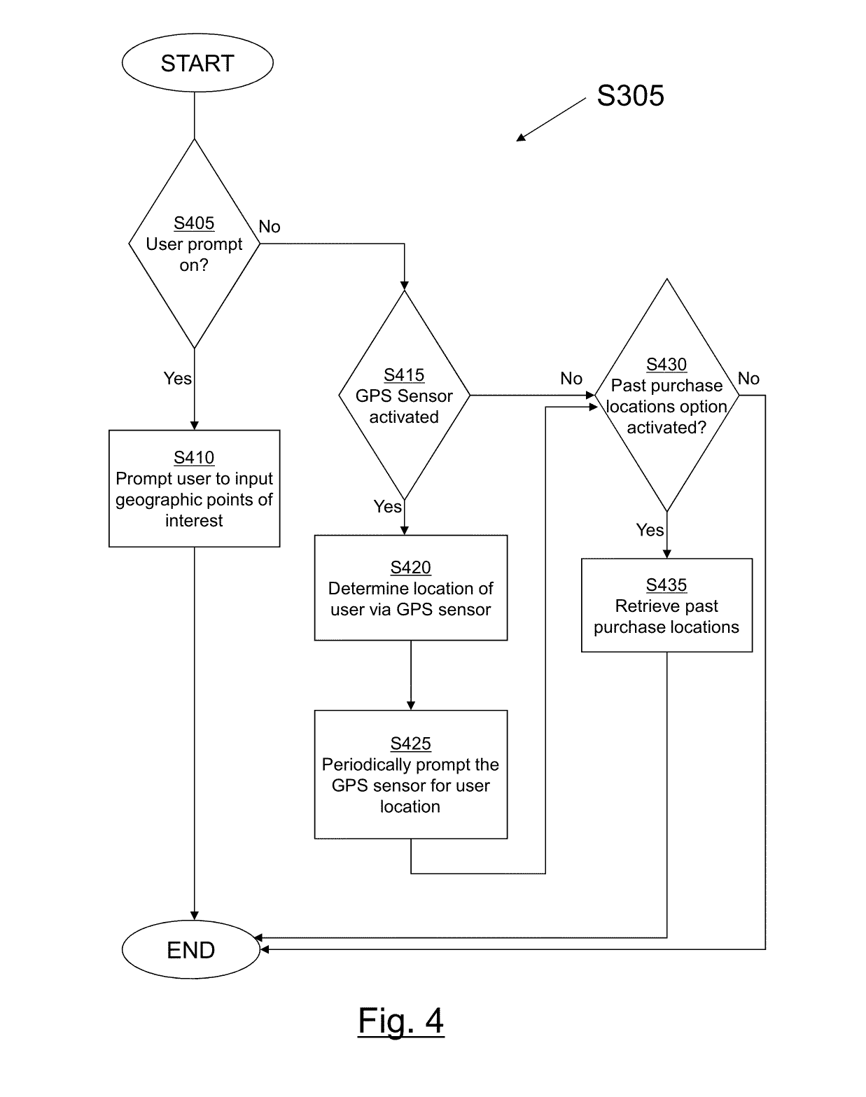

FIG. 4 is a flow chart illustrating a more detailed description of S305, in which geographic points of interest are determined. The process starts at S405, where it is determined whether a user prompt is currently activated. If the user prompt is activated, the process proceeds to S410 where the system prompts the user to input geographic points of interest. For example, the system may prompt the user to input a location of the user's home, the user's work, the location of the user's children's school, or any other locations that the user frequently visits. After the user enters geographic points of interest, the manually-input geographic points of interest are established as the geographic points of interest and the process according to S305 ends.

If the user prompt is not activated, the user device 100 can automatically determine geographic points of interest based on various factors discussed below. Each of these factors may be toggled on or off as desired by the user to provide a more custom-tailored list of geographic points of interest. For example, as shown in FIG. 4, if the user prompt is not on, the process may determine whether the GPS sensor has been activated in S415. If the GPS sensor has been activated, the process may proceed to S420, in which the GPS sensor determines the location of the user. The user location determined in S420 can be established as a geographic point of interest either separate from or in addition to other geographic points of interest established based on other factors. Alternately, or in addition to the above, the server 105 and/or the network 110 can prompt the GPS sensor for the user location, as depicted in S425. Following this process, or if the GPS sensor is not activated, the process proceeds to S430.

In S430, it is determined whether a past purchase locations option has been activated within the user device. In an embodiment, this option is adapted to determine the past locations that the user purchased goods or services under the assumption that a user is more likely to purchase goods or services in locations where he or she previously conducted consumer transactions. If the past purchase locations option is activated, the process proceeds to S435 where the user device 100 retrieves past purchase locations from the server 105, the memory 230, or another storage device within the network 110. For example, the user device 100 may store in the memory 230 various purchase locations manually or automatically input into the memory 230. The user device 100 can also retrieve from the server 105 or another data storage device on the network 110 information from the user's credit card company, bank, or other commercial organization (e.g., PayPal®) to determine the location in which the user purchased items in the past. Once the geographic point of interest has been determined in S435, the process according to S305 ends. Alternately, if the past purchase locations option is not activated, the process according to S305 ends without attempting to retrieve the past purchase locations as depicted in S435.

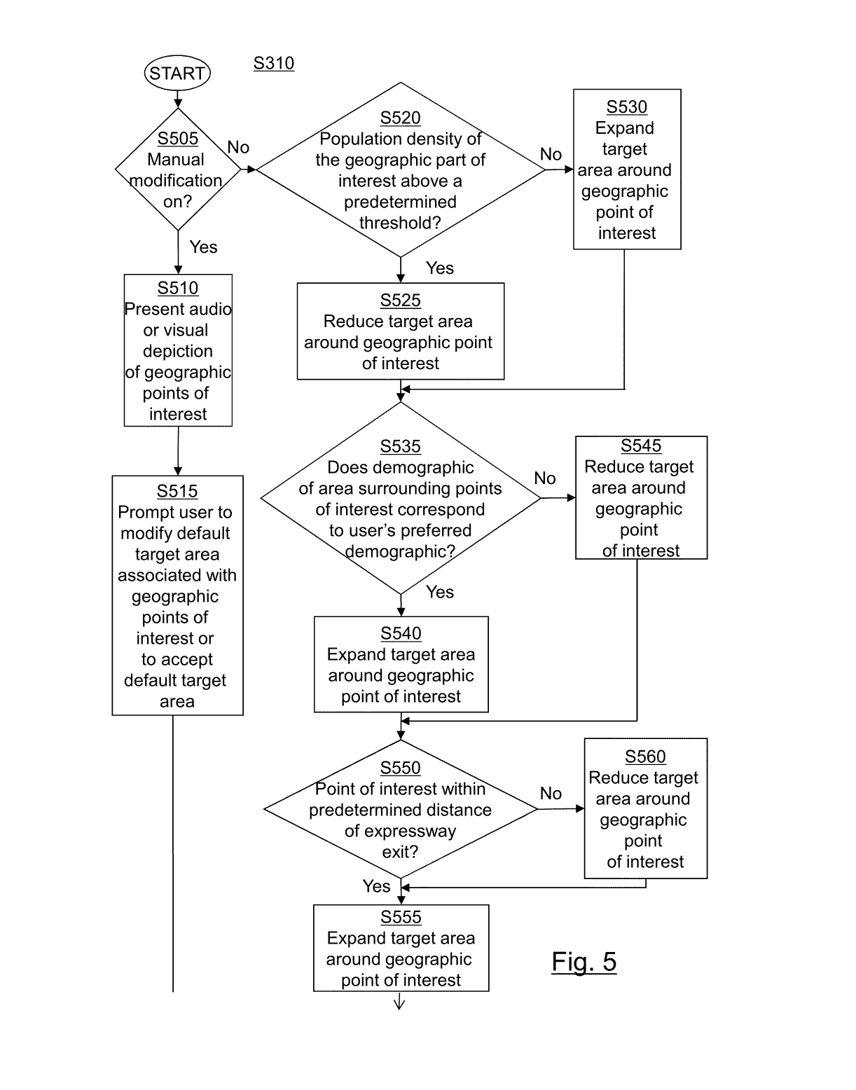

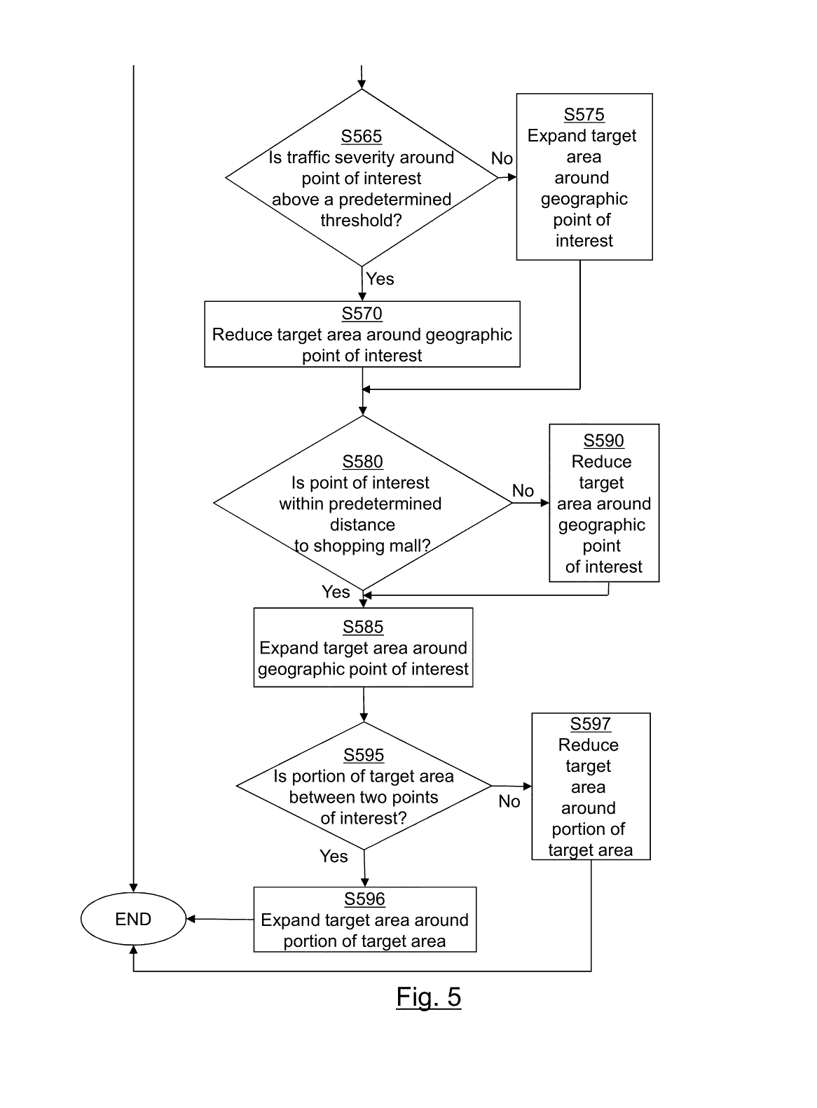

FIG. 5 illustrates a flow chart in which the target area is generated according to S310 based on the geographic points of interest that have been established in S305, as discussed above. In an embodiment, the process begins at S505, where it is determined whether the manual modification option is on. If the manual modification option is on, the process proceeds to S510, where audio and/or visual depictions of the geographic points of interest are presented to the user. For example, the user can view the visual depiction of the geographic points of interest on a map so the user can determine which types of manual modifications are desired to more closely tailor the target area to the user's unique travels and locations. In S515, the user device 100 prompts the user to modify the default target area associated with the geographic points of interest or to accept the default target area without modification. The default target area can include a predetermined radius surrounding the geographic point of interest, e.g., a 3-mile radius surrounding the geographic point of interest. The user can then modify the target area associated with the geographic point of interest or accept the default target area in S515. The user may wish to modify the target area based on any factor considered important to the user, for example, the population density of the geographic point of interest being above a predetermined threshold S520, S525, S530, the demographic of the area surrounding the points of interest S535, S540, S545, whether the geographic point of interest is within a predetermined distance of an expressway or highway exit S550, S555, S560, the traffic severity surrounding the geographic point of interest S565, S570, S575, whether the geographic point of interest is within a predetermined distance to a shopping mall S580, S585, S590, or whether a portion of the target area is between two geographic points of interest S595, S596, S597.

Following either the manual and/or automatic analysis, the process according to S310 is complete and the target area is established for the user. Accordingly, the process according to S310 ends following the manual and/or automatic analysis of the geographic points of interest.

It is noted that many of the above modifications have been discussed as being made to geographic points of interest rather than to sections of the target area that are not necessarily geographic points of interest. It should be noted that any of the above manual or automatic modifications can be made either to an established geographic point of interest or a portion of the target area not input by the user or determined automatically by the user device 100 to be a geographic point of interest. For example, a specific portion of the target area between the user's home and work can be analyzed to determine whether that specific portion of the target area is above or below the predetermined population density threshold according to S520.

It is also noted that many of the automatic modifications assume that the user will choose either an automatic or manual modification process, but not both. However, it should be noted that the user can have sole discretion to either manually or automatically, or both manually and automatically modify his or her target area depending on factors relevant to his or her routine. In addition, the modifications can be expanded or reduced variably. For example, the user may choose to expand his or her target area by a 1-mile radius if the portion of the target area or geographic point of interest is above the predetermined threshold for the population density in accordance with S520, but may choose to expand or reduce the target area surrounding the geographic point of interest or a portion of the target area by 3 miles if the demographic of that area matches the preferred demographic of the user. It will further be appreciated that the present invention can operate with one or more of the above-described automatic or manual modifications, and not all. Accordingly, each above described automatic or manual modification is optional, exemplary and non-exhaustive.

FIGS. 6(a)-(c) shows a display of a n exemplar map with specific geographic points of interest chosen manually by a user. As shown in FIG. 6(a), in this example, the user lives in the Chicago metropolitan area, and has manually chosen the Lincolnwood area as the location of his or her home. The process then prompts the user to input the location of his or her place of business, which is in the downtown loop area of Chicago, as shown in FIG. 6(b). The user can then input any other location as a geographic point of interest, e.g., the school of the children of the user, as shown in FIG. 6(c).

As shown in FIG. 7(a), the user can modify the target area by using an input device (e.g., a computer mouse, touchpad, touch screen, or audio recognition) and dragging the default radius, shape and/or size on any one of the geographic points of interest. As shown in this example, the user decided to modify the target area associated with the user's work. The user decided to shrink the target area surrounding this geographic point of interest to exclude the southern end thereof, which the user is less likely to be on a regular basis. Of course, any other modifications, including enlarging and shrinking the target area or modifying the shape, can be performed by the user based on any factor the user deems relevant. As shown in FIG. 7(b), the target areas surrounding the geographic points of interest have merged in accordance with the factors determined in S310 to form a custom target area for the individual user.

It is noted that many of the above examples provide a target area associated with the user's home and work locations, which would generally be located within the same metropolitan area. However, the user may create a separate profile for a separate metropolitan area, e.g., if the user has a vacation home in another metropolitan area. For example, if the user lives in New York, but regularly vacations in Miami, the user may create a separate profile for his or her Miami home with its own set of geographic points of interest and its own target areas. The separate profile can temporarily replace and suspend the original target area or can maintain both target areas simultaneously. By suspending the original target area, the user can avoid receiving commercial offers from within his or her regular shopping area while temporarily absent.

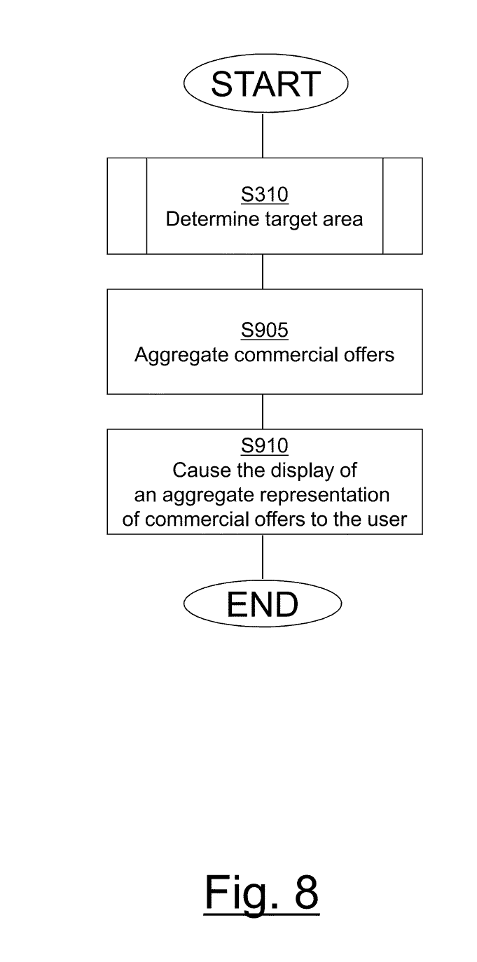

FIG. 8 illustrates an embodiment of the present invention that presents aggregated commercial offer data to the user. As shown, the process according to FIG. 8 begins and proceeds to step S310, where the target area is determined as discussed above. The system then aggregates the commercial offers for vendors located within the target area S805 and causes the display of the commercial offers S810 on the user device 100.

As shown in FIG. 8, an embodiment of the present invention aggregates commercial offers and presents the commercial offers to the user in a manner that encourages the user to purchase at least one of the commercial offers. For example, the present invention can aggregate together all of the commercial offers within the target area, all of the savings represented by the commercial offer, the total amount of savings that will expire within a predetermined period, or any of the above with respect to a category of product. The aggregated commercial offer can then be displayed on, for example, a map to visually illustrate the potential savings to the user. The commercial offers are thus provided to the user in a more powerful format by causing a sense of urgency when the user sees that certain deals are soon to expire or that a great savings opportunity exists when, e.g., the user sees that he or she can save a maximum of $5,000 in their target area. As a result, the user is more likely to purchase at least one commercial offer within their target area.

The data related to the commercial offers can be aggregated together as aggregated commercial offer data and can be presented to the user in any manner. For example, the aggregate commercial offer data can be displayed on a map of the user device 100 showing, e.g., the total amount of savings within the user's target area. The aggregate commercial offer data can also be displayed in table, window, or “bubble” format. Any other method of communicating the aggregate commercial offer data, whether audibly or visually, can be implemented without departing from the sprit and scope of the present invention.

The same commercial offer can also be provided to a plurality of users, but with a different expiration date for each user or group of users. In this manner, the commercial offer can be staggered across a period of time rather than overwhelming the vendor with a large increase in temporary business due to a plurality of customers using commercial offers. Vendors can also limit the number of commercial offers that are submitted to users and spread out the limited number of offers over a larger period of time. Collectively, the total commercial offer pendency can extend over a larger period of time as compared to a conventional commercial offer because the commercial offer is not available to all users at the same time. Moreover, commercial offers can be advertised in print or other non-electronic formats due to this longer life span.

The system according to the present invention can include user(s) in a first category, and user(s) in a second category, where the commercial offer can be valid at different times for the two categories. Of course, any number of categories may be used such that every commercial offer has a different start and end date in which the commercial offer is valid.

A fraud detection tool can optionally be incorporated into this embodiment to detect whether a user is creating a fictitious user account to obtain access to commercial offers having different expiration periods. For example, the fraud detection tool can determine when a person or group of users creates an account with the same user name, password, first or last name, credit card number, address, or any other identifying information. An administrator or employee of the commercial offer system can be notified once the fraud detection tool determines that a fictitious account has been created.

In an embodiment, the commercial offer need not have the same amount of savings over the life of the commercial offer. As discussed above, many commercial offer systems provide coupons to users as a customer acquisition tool. The savings are usually static, e.g., 30% off a cheeseburger at a local restaurant. A user may purchase the commercial offer and conduct repeat business with the restaurant even when a 30% off coupon is not available. However, such repeat business is difficult to quantify and the commercial offer system may not receive the appropriate recognition for obtaining the repeat customer. Accordingly, in an embodiment, the savings of the commercial offer can decrease over time from a “customer-acquisition rate” (e.g., 30% off a cheeseburger) to a rate that may be more sustainable for the vendor (e.g., 5% off). The 5% off coupon rate is small enough that the restaurant does not feel a significant economic impact, and yet the commercial offer system can still maintain a record of how many repeat customers were acquired by the commercial offer system.

The variable discount amount of the commercial offer can be referred to as the “discount schedule” of the commercial offer. The discount schedule can include a gradual or instantaneous decrease in the discount amount. For example, the discount amount can decrease by 5% each week, or can start at a high discount amount and decrease to a lower discount without any other intermediary discount. Any other method of establishing a discount schedule can be implemented without departing from the sprit and scope of the present invention.

It should also be noted that the above-referenced embodiments may be implemented independent of one another or in combination with one another. For example, in an embodiment, the present invention includes a commercial offer system that presents aggregated commercial offer data in a time-staggered manner with a variable discount amount.

The matter set forth in the foregoing description and accompanying drawings and examples is offered by way of illustration only and not as a limitation. More particular embodiments have been shown and described, and it will be apparent to those skilled in the art that changes and modifications may be made without departing from the broader aspects of Applicant's contribution. The actual scope of the protection sought is intended to be defined in the following claims when viewed in their proper prospective based on the prior art.

What is claimed is:

1. A method of providing commercial offers to a user comprising:
determining a geographic target area of the user;
determining the commercial offers that are within the geographic target area of the user;
aggregating the commercial offers, with a server associated with a processor, to create aggregated commercial offer data; and
causing the display of the aggregated commercial offer data on a user device.

2. The method of claim 1, wherein the aggregated commercial offer data includes at least one of a total number of commercial offers within the geographic target area, a total amount of discount available for the geographic target area, and a total amount of discount available within the geographic target area that will expire within a predetermined time.

3. The method of claim 2, wherein the aggregated commercial offer data is displayable on a map.

4. The method of claim 1, wherein the step of determining the geographic target area includes determining a geographic point of interest of the user.

5. The method of claim 4, wherein the step of determining the geographic point of interest of the user includes receiving a user input of the geographic point of interest.

6. The method of claim 4, wherein the step of determining the geographic target area includes modifying, by input of the user, a size or shape of a default geographic target area surrounding the geographic point of interest.

7. A method of providing a commercial offer to a user comprising:
determining whether the user is in a first category or a second category with a server having a processor;
establishing a start time for the commercial offer identifying a time in which the commercial offer will become valid; and
establishing an end time for the commercial offer identifying a time in which the commercial offer will no longer be valid,
wherein the start time and the end time are different depending on whether the user is in the first category or the second category.

8. The method of claim 7, wherein the first category and the second category respectively represents groups of users.

9. The method of claim 7, further comprising a fraud detection system adapted to determine whether the user created another account capable of accessing the commercial offer.

10. The method of claim 9, wherein the fraud detection system determines whether the user created another account by determining whether two or more accounts exist with the same at least one of a name, a credit card number, an email address, and a mailing address.

11. The method of claim 7, wherein the commercial offer is adapted to be presented to the user in a non-electronic format.

12. A method of presenting a commercial offer to a user comprising:
establishing a discount amount of the commercial offer;
determining, by a server having a processor, a discount schedule wherein the discount amount of the commercial offer is changed over a period of time; and
causing the commercial offer to be displayed on a user device.

13. The method of claim 12, wherein the discount schedule includes, as the discount amount, only a start discount amount and an end discount amount.

14. The method of claim 12, wherein the discount schedule includes a plurality of discount amounts that decrease over time.

15. A method of providing commercial offers to a user comprising:
determining a geographic target area of the user;
determining the commercial offers that are within the geographic target area of the user;
aggregating the commercial offers, with a server associated with a processor, to create aggregated commercial offer data;
determining whether the user is in a first category or a second category with the server having the processor;
establishing a start time for the commercial offer identifying a time in which the commercial offer will become valid;
establishing an end time for the commercial offer identifying a time in which the commercial offer will no longer be valid, wherein the start time and the end time are different depending on whether the user is in the first category or the second category; and
determining, by the server having the processor, a discount schedule wherein a discount amount of the commercial offer is changed over a period of time.

16. The method of claim 15, wherein the step of determining the geographic target area includes determining a geographic point of interest of the user.

17. The method of claim 15, wherein the step of determining the geographic point of interest of the user includes receiving a user input of the geographic point of interest.

18. The method of claim 15, wherein the step of determining the geographic target area includes modifying, by input of the user, a size or shape of a default geographic target area surrounding the geographic point of interest.

19. The method of claim 15, further comprising a fraud detection system adapted to determine whether the user created another account capable of accessing the commercial offer.

20. The method of claim 15, wherein the commercial offer is adapted to be presented to the user in a non-electronic format.
